(19) United States
(12) Patent Application Publication
(10) Pub. No.: US 2003/0019650 A1
(43) Pub. Date: Jan. 30, 2003

(54) Process adapter

(76) Inventors: Robert Schmidt, Schopfheim (DE); Hans-Jorg Florenz, Maulburg (DE)

Correspondence Address: Felix J. D'Ambrosio, JONES, TULLAR & COOPER, P.C., Eads Station, P.O. Box 2266, Arlington, VA, 22202, US

(21) Appl. No.: 10/146,070

(22) Filed: May 16, 2002

Related U.S. Application Data
(60) Provisional application No. 60/310,253, filed on Aug. 7, 2001.

(30) Foreign Application Priority Data
May 18, 2001 (DE) 101 24 678.1

(51) Int. Cl. H02G 3/18

(52) U.S. Cl. 174/65 R

(57) ABSTRACT

The invention relates to a universal process adapter (10) having a housing (112), a probe in the form of a rod or cable, and a standardized attachment apparatus (130), by means of which the process adapter can have any desired further housing (212) added to it.

### BACKGROUND OF THE INVENTION

1. Field of the Invention

The invention relates to a process adapter having a housing and at least one probe in the form of a rod or cable. The invention relates in particular to such a process adapter in which the probe which is in the form of a rod or cable is used for measuring a physical variable or a state of a medium, such as its temperature, pressure, limit state or filling level, in a container.

2. Description of the Prior Art

Known process adapters of this type are attached to the container or mounted on the container by means of a process adapter apparatus, in such a manner that the probe which is in the form of a rod or cable projects into the container. In this case, depending on the application, it is also possible to provide for the probe which is in the form of a rod or cable to be immersed in the medium. The probe which is in the form of a rod or cable itself comprises, for example, one or more metal or metalized rods, which are used as electrodes. The probe, which is in the form of a rod or cable, may, however, also be a cable to whose end which projects into the container a separate sensor element, normally an electrical transducer such as a pressure sensor, is attached.

In the described cases, the probe projects, or its individual rods or the electrical conductors of the cable project, into the interior of the housing of the process adapter, where electrical contact is made with them. The rods, the cable or its electrical conductors are mechanically securely attached, and frequently also such that they are liquid-tight and/or gas-tight, in the housing area which faces the container, or which projects into it there.

A disadvantage that has been found with the previously known process adapters of this type is that they are designed with different housing shapes and sizes depending on the application. The manufacturers of such process adapters have to provide a large number of widely differing configurations, and this has a negative effect on the production and storage costs, and thus, finally, on the selling price.

Another problem with a number of known process adapters is that they can be used only for one specific application. For example, if a user of such a process adapter which is equipped with a conductive probe for detecting a limit state of the medium in the container wishes to have a switching output in addition to the measurement signal output, by means of which switching output a pump can be switched on and off as a function of the detected limit state, he normally has to remove the installed process adapter and replace it by a different appliance having a switching output.

### SUMMARY OF THE INVENTION

It is therefore the object of the invention to avoid the drawbacks mentioned above and to provide a process adapter which can be used universally, which is designed in as simple a manner as possible depending on the application and is thus as physically small as possible, but which can also be upgraded for additional applications and whose safety is improved.

This object is achieved by a process adapter having

a housing which is in the form of a pot,

an internal area located inside it,

a holding apparatus for at least one probe in the form of a rod or cable,

which probe projects into the internal area,

a process adapter apparatus and

through which a cable, by means of which measurement and/or switching signals are transmitted, can be passed out of the internal area,

with the housing, which is in the form of a pot, having a standardized attachment apparatus on its side facing away from the process, where it can be sealed.

The essential idea of the invention is to provide a relatively simple process adapter for at least one probe in the form of a rod or cable, which process adapter can itself be used for the intended application, for example as a limit state transmitter, but which can be combined with a further additional housing or a further apparatus by connection via a standardized attachment apparatus in its area facing away from the container.

Another preferred embodiment of the invention thus relates to a process adapter whose housing, which is in the form of a pot, is sealed by, and has added to it, a second housing which holds an electronic circuit.

A further preferred embodiment of the process adapter according to the invention is provided by also accommodating an electronic circuit in its housing which is in the form of a pot.

With this embodiment, it is possible, first of all, to accommodate a minimal electronic circuit in the housing, which is in the form of a pot, of the process adapter, and whose internal area is intrinsically quite limited. If the user then requires a further, more complicated electronic circuit, he can accommodate this in a second housing with a larger internal area, and the second housing can be mounted on the process adapter. In this way, if the medium in the container is hot, the housings can be thermally isolated from one another and the more sensitive electronic circuit can thus be accommodated in the outer, second housing.

Other preferred embodiments of the invention relate to the electrical connections between the electronic circuit and the probe, which in turn can also themselves be connected to one another.

Yet another embodiment of the invention relates to a process adapter in which the second housing has at least one cable bushing, through which a cable which is used for transmitting measurement and/or switching signals can be passed out of the second housing.

Such an embodiment is particularly advantageous for a permanently installed process adapter according to the invention which, for example, has a cable bushing for a measurement cable output. If an additional switching output is subsequently desired, a second housing with such a switching output is simply connected, according to the invention, to the housing, which is in the form of a pot, via the standardized attachment apparatus The additional switching output is achieved without needing to replace the already installed process adapter. It is just added to, as desired. This is particularly important for a process adapter on a pressurized container or on a container containing a hazardous medium, which must not escape to the atmosphere. If the holding apparatus for the probe is designed to be gas-tight and pressure-tight in the normal manner, there is no need to depressurize the container or to empty out the medium, or to remove or replace the installed process adapter. The originally installed process adapter according to the invention can remain on the container and just has an additional housing, which is attached to the process adapter, added to it.

In yet another preferred embodiment of the process adapter according to the invention, cables carrying measurement signals are passed through the cable bushing in the second housing, and cables carrying switching signals are passed through the cable bushing in the housing which is in the form of a pot.

The particular advantage of this embodiment is that the internal areas of the two housings can be designed such that they are separated from one another, thus satisfying explosion-protection regulations. It is thus possible to clearly separate the measurement cable outputs and switching outputs from one another, to be precise not just physically, but also for safety purposes.

Further refinements of the invention relate to the process adapter apparatus, which may be a flange or comprises an external thread on a connecting region.

Another particular advantage of the process adapter according to the invention is that, if the container contains a corrosive or highly corrosive medium, the only part which need be manufactured from corrosion-resistant material is that which is in contact with the interior of the container. This may be the corresponding part of the holding apparatus for the probe for the process adapter, but may also be the entire process adapter, if it is very small. The additional second housing can then be manufactured from any desired material. Overall, the invention allows housings to be combined which are each manufactured from any desired different material, provided the specific requirements for the applications are observed. It is likewise, of course, possible to replace a second housing, which is mounted on the housing in the form of a pot, by another second housing at any time if this is desirable or is required due to a change in the operating conditions, for example.

The invention will be described and explained in more detail in the following text with reference to a preferred exemplary embodiment and with the assistance of drawings, in which:

### BRIEF DESCRIPTION OF THE DRAWINGS

FIG. 1 shows a schematic section illustration of a process adapter according to the invention; and

FIG. 2 shows a schematic section illustration of the process adapter shown in FIG. 1, having a second housing mounted on it, on a smaller scale.

### DESCRIPTION OF THE PREFERRED EMBODIMENTS OF THE INVENTION

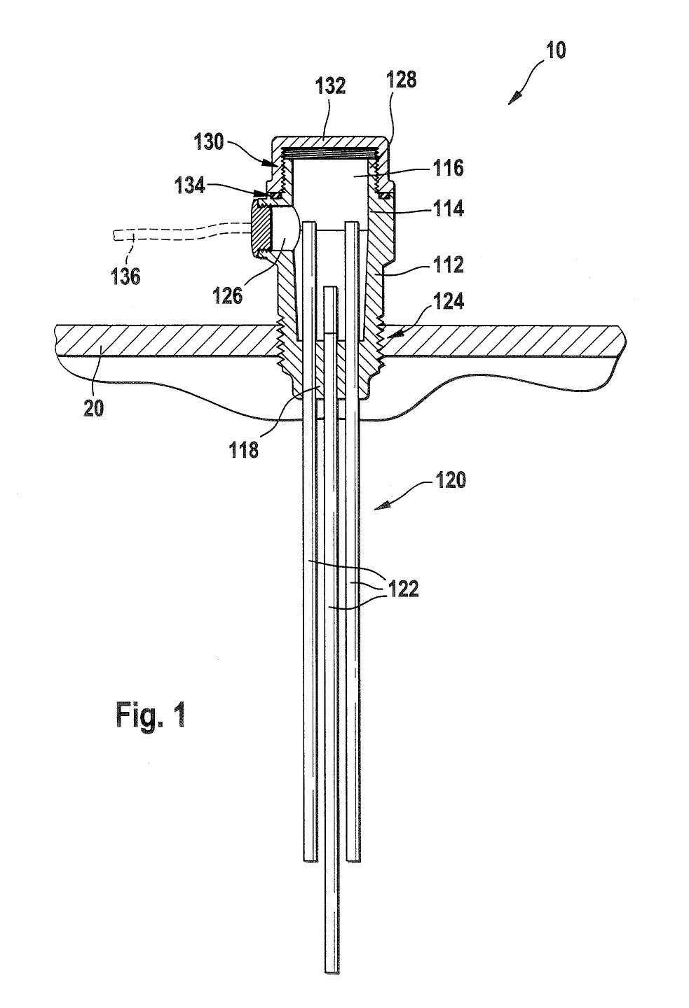

FIG. 1 shows a process adapter 10 according to the invention, which is mounted in a wall 20 of a container, which is not shown in any more detail here. The process adapter 10 comprises a housing 112 which is in the form of a pot and whose wall 114 encloses an internal area 116. A holding apparatus 118 is provided virtually in the bottom of the housing 112, which is in the form of a pot, for a probe 120 which is in the form of a cable or rod and, in this exemplary embodiment, comprises three rods 122 which project into the internal area 116 of the housing 112, which is in the form of a pot. The rods 122 are metallic rods and, for the application of the process adapter 10 illustrated here, are used, for example, in the form of a conductive probe as electrodes for detecting a limit state of a medium which is located in the container, but which is not illustrated here, for simplicity reasons. The measurement principle of such conductive probes is known per se, and will thus not be explained in any more detail here.

The exemplary embodiment illustrated here has three electrodes in the form of rods, but there may also be two electrodes, or else more than three, for other conductive measurements without any restriction to the invention. It is likewise feasible to fit other probes in the form of rods to the process adapter 10 according to the invention, for example for capacitive measurements, or to use it for other measurement probes, in the form of cables. For example, the process adapter according to the invention may then comprise a cable rather than the three metallic rods illustrated here, to whose lower end, which projects as deeply as possible into the container and the medium, a pressure measurement element is fitted in order to determine the filling level of the medium hydrostatically. In this respect, the invention can be used in a versatile manner and is not limited to the applications illustrated and described. However, with probes in the form of rods or cables, the holding apparatus 118 for the housing 112 which is in the form of a pot is used not only for adequate mechanical security of the probe in the form of a rod (120) or cable, but is also designed to be as liquid-tight and, even better, gas-tight as possible, in order to prevent the medium escaping from the container, either in liquid or gaseous form, into the housing 112, which is in the form of a pot, and from there, possibly, further into the atmosphere.

The process adapter 10 is mounted by means of a process adapter apparatus 124 in the wall 20 of the container, in which case this process adapter apparatus 124 is preferably, as shown in FIG. 1, a screw adapter, with the housing 112, which is in the form of a pot, being provided with an external thread in the region of the process adapter apparatus 124 and being screwed into a corresponding internal thread in the wall 20 of the container. It is also feasible for the process adapter apparatus to be a flange connection, which is not illustrated here, or another suitable adapter apparatus, such as bonded or push-in apparatuses, which are designed to be as liquid-tight as possible and, if the application requires this, also to be gas-tight. The sealing means required for this purpose are not shown, for reasons of clarity, for the process adapter apparatus 124 illustrated in FIG. 1, since they are sufficiently well known to those skilled in the art. On the other hand, adapter pieces or adapter rings are also conceivable, which are placed on the process adapter apparatus and thus enlarge their effective external diameter, or adapt it such that they can also be used for openings in a container wall whose diameter does not match the original process adapter apparatus, without an adapter

The housing 112, which is in the form of a pot, is provided with a first cable bushing 126 which, in the exemplary embodiment of the invention illustrated in FIG. 1, is sealed by a cover which is not shown in any more detail here. The first cable bushing 126 in the exemplary embodiment of the invention illustrated in FIG. 1 is designed in a manner which is known per se. However, cable bushings need not always be provided with blanking plugs by the manufacturer, but may also be of a type in which an aperture which is provided in the wall 114 on delivery is still sealed by housing material, but which is prepared such that, if required, the opening in the wall 114 can be produced by knocking out the seal.

The rods 122 of the probe 120 of the process adapter 10 are, as normal, connected inside the housing 112, which is in the form of a pot, to electrical conductors which are not illustrated here and are held together in a cable 136, illustrated by dashed lines here, and are passed out of the internal area 116 through the first cable bushing 126. Such a cable is used, for example, for passing on measurement signals detected by the probe 120 to an instrumentation console, or to some other appliance used for process monitoring and control.

A standardized attachment apparatus 130 is provided on the side of the process adapter 10 facing away from the container, that is to say on the side 128 facing away from the process. As illustrated in FIG. 1, this may be, for example, a thread onto which a first screw-on cover 132 is screwed, which is provided with a corresponding thread and in this way seals the housing 112, which is in the form of a pot. In order to seal the interior of the housing 112, which is in the form of a pot, in the desired manner, an O-ring seat 134 can also be provided in the region of a sealing shoulder of the first screw-on cover 132, as is shown in FIG. 1. The arrangement, shown in FIG. 1, of a standardized attachment apparatus 130 on the housing 112, which is in the form of a pot, and the corresponding thread on the first screw-on cover 132 are chosen by way of example.

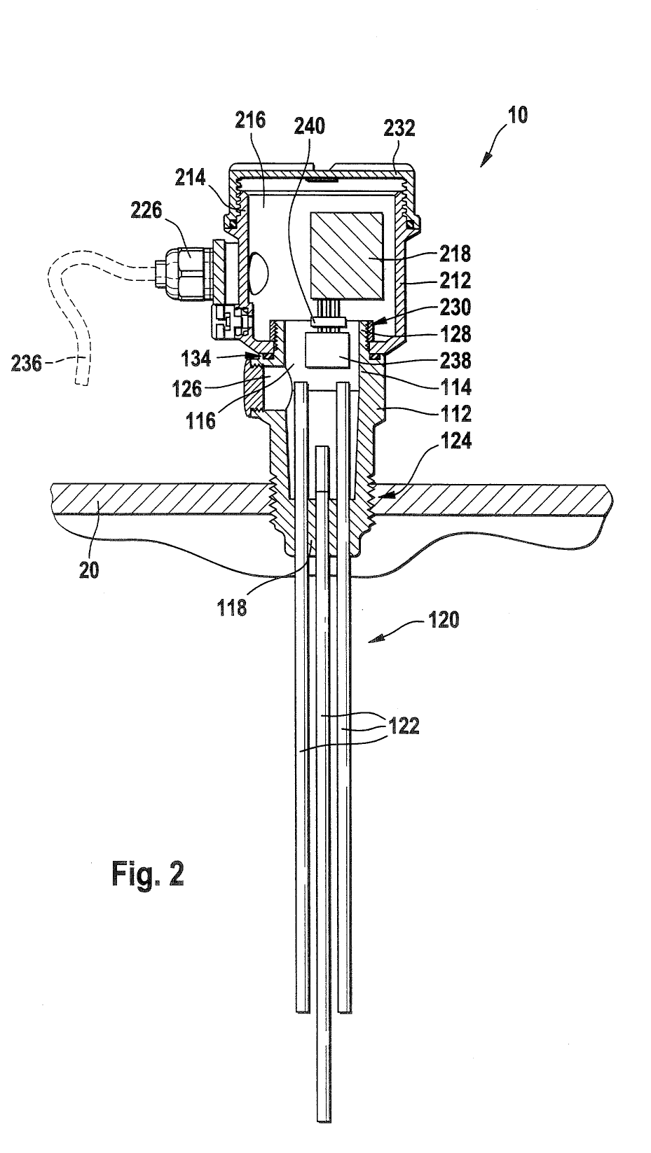

FIG. 2 shows a further embodiment of this process adapter 10 shown in FIG. 1. Identical elements and components of the process adapter 10 are annotated with the same reference symbols. In comparison to the process adapter in FIG. 1, the process adapter in FIG. 2 has had a second housing 212 added to it. As is illustrated in FIG. 2, the second housing 212 is preferably provided with a thread corresponding to the standardized thread 130 (see FIG. 1) and, instead of the first screw-on cover 132 (see FIG. 1), is screwed onto the housing 112, which is in the form of a pot, on the side facing away from the container 20. However, it is invariably conceivable, and possible without any restriction to the invention, to provide the desired pair of threads by means of an internal thread in the housing 112, which is in the form of a pot, and an external thread on a corresponding part of the screw-on cover. Furthermore, widely differing forms and types of thread may also be used, provided they ensure the desired mechanical characteristics and/or satisfy the relevant sealing requirements. Furthermore, it is also conceivable to use other types of attachments, such as bonded connections, push-in connections, those with attachment clips or even those with adapters, which are arranged between the housing 114, which is in the form of a pot, and the second housing 212. This allows the process adapter 10 to be used universally with virtually any conventional housings for in-field test equipment as the second housing 212.

In a similar way to the housing 112, which is in the form of a pot, a wall 214 of the second housing 212 encloses an internal area 216 which is used to hold a first electronic circuit 218. The second housing has a cable bushing 226 through which a cable 236, which is represented here by a dashed line and is connected, for example, to the first electronic circuit 218, is passed. As mentioned, the second housing 212 is preferably a conventional standard housing for in-field test equipment for process instrumentation and, as is normal with such equipment, is sealed by a second cover 232, preferably a screw-on cover.

The first electronic circuit 218 may either be conductively connected to the probe 120, that is to say to the individual rods 122 of the probe or, as indicated in FIG. 2, may be electrically connected to a second electronic circuit 238 in the housing 112, which is in the form of a pot, for example via a plug connection 240. Electrical conductors from the first and/or from the second electronic circuit 218 and 238, respectively, are combined in the cable 236, which produces a connection to a higher-level unit in the panel or to the measurement console. If separate cables are desirable for measurement signal lines and for switching outputs, a further cable 136 can also be passed out through the first cable bushing 126 in the embodiment of the process adapter 10 according to the invention illustrated in FIG. 2, in a similar way to that illustrated in FIG. 1.

What is claimed is:

1. A process adapter (10) having
a housing (112) which is in the form of a pot,
an internal area (116) located inside it,
a holding apparatus (118) for at least one probe (120) in the form of a rod or cable,
which probe (120) projects into the internal area (116),
a process adapter apparatus (124) and
through which a cable (136), by means of which measurement and/or switching signals are transmitted, can be passed out of the internal area (116),
with the housing (112), which is in the form of a pot, having a standardized attachment apparatus (130) on its side facing away from the process, where it can be sealed.

2. The process adapter as claimed in claim 1, whose housing (112), which is in the form of a pot, is sealed by a second housing (212) which holds a first electronic circuit (218).

3. A standardized process adapter as claimed in one of claims 1 or 2, in whose housing (112), which is in the form of a pot, a second electronic circuit (238) is accommodated.

4. The process adapter as claimed in one of claims 1 to 3, in which the first electronic circuit (218) is connected to the probe (120).

5. The process adapter as claimed in one of claims 1 to 3, in which the second electronic circuit (238) is connected to the probe (120).

6. The process adapter as claimed in one of claims 1 to 5, in which the electronic circuits (218, 238) are connected to one another.

7. The process adapter as claimed in one of claims 1 to 6, in which the second housing (212) has at least one cable bushing (226), through which a cable (236) which is used for transmitting measurement and/or switching signals is passed out of the second housing (212).

8. The process adapter as claimed in claim 7, in which the cable (236) carrying measurement signals is passed through the cable bushing (226) in the second housing (212), and the cable (136) carrying the switching signals is passed through the cable bushing (126) in the housing (112) which is in the form of a pot.

9. The process adapter as claimed in claim 7, in which the cable (136) carrying the switching signals is passed through the cable bushing (226) in the second housing (212), and the cable (236) carrying measurement signals is passed through the cable bushing (126) in the housing (112) which is in the form of a pot.

10. The process adapter as claimed in one of claims 1 to 9, in which the process adapter apparatus (124) is a flange.

11. The process adapter as claimed in one of claims 1 to 9, in which the process adapter apparatus (124) comprises an external thread on a connecting region of the process adapter (10).
